(19) United States
(12) Patent Application Publication
(10) Pub. No.: US 2025/0139770 A1
(43) Pub. Date: May 1, 2025

(54) DIGESTIVE SYSTEM PATHOLOGY IMAGE RECOGNITION METHOD AND SYSTEM, AND COMPUTER STORAGE MEDIUM

(71) Applicant: ANKON TECHNOLOGIES CO., LTD, Wuhan (CN)

(72) Inventors: Chukang ZHANG, Wuhan (CN); Hao ZHANG, Wuhan (CN); Zhiwei HUANG, Wuhan (CN); Fanhua MING, Wuhan (CN)

(73) Assignees: ANKON TECHNOLOGIES CO., LTD, Wuhan, CN (CN); ANX IP HOLDING PTE. LTD., SG (SG)

(21) Appl. No.: 18/727,097

(22) PCT Filed: Jan. 6, 2023
(86) PCT No.: PCT/CN2023/071024

§ 371 Date: Jan. 13, 2025

(30) Foreign Application Priority Data
Jan. 7, 2022 (CN) 202210013379.4

(51) Int. Cl. G06T 7/00; G06N 3/0442; G06N 3/045; G06N 3/0464; G06N 3/0895; G06V 10/774

(52) U.S. Cl. CPC G06T 7/0012; G06N 3/0442; G06N 3/045; G06N 3/0464; G06N 3/0895; G06V 10/774; G06T 2207/20081; G06T 2207/30004

(57) ABSTRACT

The present invention discloses a digestive system pathology image recognition method and system, and a computer storage medium. The method includes: acquiring image data to be detected; constructing and loading a first learning model, and executing regional traversal prediction on the image data, so as to obtain a plurality of predicted probability values; performing screening to obtain sub-region image data, which meets a preset assessment condition, so as to form an intermediate feature sequence; and constructing and loading a second learning model, executing traversal prediction on the intermediate feature sequence, and generating and outputting pieces of predicted sub-region image data and final probability values of the pieces of predicted sub-region image data.

This application claims priority to Chinese Patent Application No. 202210013379.4, titled “Digestive System Pathology Image Recognition Method and System, and Computer Storage Medium”, filed on Jan. 7, 2022, which is hereby incorporated by reference in its entirety.

### FIELD OF INVENTION

The present invention relates to an image processing technology, and more particularly to a digestive system pathology image recognition method and system, and a computer storage medium.

### BACKGROUND

How to analyze pathology image data efficiently and accurately, especially the pathology image data of malignant tumors of the digestive tract, has always been a topic of great concern in the medical field. The current artificial intelligence applications for pathology images may be roughly divided into two general directions: qualitative diagnosis and lesion identification. Due to limitations in computational load capacity, the modeling approach is usually configured as: according to Convolutional Neural Network (CNN), especially loading a Supervised Learning model or a Weakly Supervised Learning model, where medical professionals input pathological diagnostic data into the model for training, which is then used for the recognition and diagnosis of new pathology images.

However, due to the inherent flaws of CNNs, their output results are heavily dependent on input data. The adjustment of model parameters requires extensive sample training, demanding high processor performance for thorough training. Insufficient training will lead to large errors in output determination results. Even with subsequent integration of fusion models, the determination results still depend on the output of the CNN, making it difficult to offset inaccuracies through weighted fusion. Consequently, this can cause confusion in the pathological identification and determination process for medical professionals.

### SUMMARY OF THE INVENTION

It is one object of the present invention to provide a digestive system pathology image recognition method to address the technical issues in the prior art that the pathology image recognition process has too high performance requirements and inaccurate determination results.

It is another object of the present invention to provide a digestive system pathology image recognition system.

It is still another object of the present invention to provide a computer storage medium.

In one embodiment of the present invention, a digestive system pathology image recognition method is provided, comprising: acquiring image data to be tested; constructing a convolutional neural network to form and load a first learning model, and executing a regional traversal prediction on the image data to be tested using a first model parameter set, to obtain a plurality of predicted probability values corresponding to a plurality of sub-region image data; screening the sub-region image data whose predicted probability values meet the preset assessment condition, to form an intermediate image data set, and extracting feature vectors of the intermediate image data set according to the first model parameter set to form an intermediate feature sequence; constructing a recurrent neural network to form and load a second learning model, and executing a traversal prediction on the intermediate feature sequence by means of a second model parameter set, and generating and outputting pieces of predicted sub-region image data and final probability values of the pieces of predicted sub-region image data according to the sub-region image data, the final probability value of which meet a preset output condition.

Further, the first learning model is a weakly supervised learning model, and the second learning model is a long short-term memory learning model. The method further comprises: removing the fully-connected layer of the first learning model to form a feature extraction model, and extracting feature vectors of the intermediate image data set according to the first model parameter set to form an intermediate feature sequence.

Further, the method further comprises: acquiring the original image data, calculating a staining vector matrix and a staining density matrix of the original image data to obtain an original vector matrix and an original density matrix, and calculating the maximum quantile value of the original density matrix as the maximum original density data; calculating a migration coefficient according to a maximum reference density data and the maximum original density data, and updating the original density matrix using the migration coefficient to obtain an updated density matrix; calculating an image matrix to be tested according to a reference vector matrix and the updated density matrix, where the reference vector matrix is the staining vector matrix of at least one set of high-staining-quality image data, and the maximum reference density data is the maximum quantile value of the staining density matrix of the high-staining-quality image data.

Further, the method specifically comprises: acquiring the original image data, performing a color space conversion on the original image data, and deleting elements in the converted original image data that are less than a preset original threshold to form an original optical density matrix; calculating the covariance of the original optical density matrix row by row to form an original covariance matrix, calculating the feature vectors according to the original covariance matrix, and performing element screening to obtain an original feature matrix; projecting the original optical density matrix according to the original feature matrix, calculating an arctangent value of the projected original optical density matrix to obtain an original arctangent matrix, and extracting the maximum quantile arctangent value and minimum quantile arctangent values from the original arctangent matrix; calculating the maximum parameter vector and the minimum parameter vector corresponding to the maximum quantile arctangent value and minimum quantile arctangent value respectively, and calculating a first staining vector and a second staining vector corresponding to the original feature matrix; arranging the first staining vector and the second staining vector according to the element values of the two to generate a staining vector matrix of the original image data, thereby obtaining an original vector matrix.

Further, the first staining vector is the dot product of the original feature matrix and the minimum parameter vector, and the second staining vector is the dot product of the original feature matrix and the maximum parameter vector. The method specifically comprises: determining whether the first element value of the first staining vector is greater than the first element value of the second staining vector; if so, arranging the first staining vector in the second to the left of the second staining vector to generate the staining vector matrix of the original image data, thereby obtaining the original vector matrix; and if not, arranging the second staining vector to the left of the first staining vector to generate the staining vector matrix of the original image data, thereby obtaining the original vector matrix. The method further comprises: performing lasso regression on the original optical density matrix using the original vector matrix as a standard to generate a staining density matrix, thereby obtaining an original density matrix.

Further, the method further comprises: traversing the image matrix to be tested, segmenting the image matrix to be tested using a sliding window of a preset size to obtain at least two sets of sub-region image data of the image matrix to be tested, and relative position data of the sub-region image data in the image matrix to be tested; traversing the grayscale data of all pixels of the sub-region image data, and calculating the ratio of the number of pixels with grayscale data values less than a preset grayscale threshold to the total number of pixels in the grayscale data, to obtain a tissue area ratio of the sub-region image data; forming the image data to be tested according to the sub-region image data that meets the preset processing condition, wherein the preset processing condition is: the tissue area ratio of the sub-region image data is greater than a preset ratio threshold.

Further, the method specifically comprises: acquiring the original image data, and constructing a surface image template with the same size as the original image data; mapping to obtain pseudo-color data corresponding to the final probability values according to the final probability values and RGB mapping curve, and mapping the corresponding pseudo-color data to the surface image template according to the relative position data of the predicted sub-region image data to generate a predicted probability distribution image; setting the predicted probability distribution image with a first weight, setting the original image data with a second weight, and performing weighted mixing on the predicted probability distribution image and the original image data to generate and output a pathological analysis image; wherein the relative position data records the relative position of the predicted sub-region image data in the original image data, the values of the first weight and the second weight range from 0 to 1, and the sum of the first weight and the second weight is equal to 1.

Further, the method further comprises: acquiring a plurality of sets of learning image data, and performing magnification standardization, color transfer standardization, and image matrix segmentation screening on the learning image data to obtain a plurality of sets of sample image data; dividing the sample image data into a first training set and a first validation set according to a preset ratio; constructing a convolutional neural network to form and load a weakly supervised learning model, calling an activation function to perform traversal inference on a plurality of first training images in the first training set, and outputting a plurality of training inference probability values corresponding to a plurality of training sub-region image data in the first training images; sorting the training sub-region image data in descending order according to the training inference probability values, and screening a preset number of high-ranking training sub-region image data to obtain a first input image data; inputting the first input image data and the corresponding preset diagnostic classification labels of the first training images into the weakly supervised learning model for training to obtain a first primary parameter set, calculating the binary cross-entropy between the training inference probability values and the diagnostic classification labels as a first-order loss function of the first primary parameter set, and updating the weakly supervised learning model with the first primary parameter set; iteratively training until the first-order loss function value converges to a preset loss interval, generating a plurality of first primary parameter sets, corresponding first-order loss function values, and corresponding first input image data; respectively loading a plurality of weakly supervised learning models under the plurality of first primary parameter sets, performing traversal inference on a plurality of validation images in the first validation set, and outputting a plurality of validation inference probability values corresponding to a plurality of validation sub-region image data in the first validation images; screening the plurality of validation inference probability values to obtain the maximum validation inference probability value as the comprehensive inference probability value of the first validation image, and calculating the binary cross-entropy between the comprehensive inference probability value and the diagnostic classification label of the first validation image as a second-order loss function of the first primary parameter set; evaluating the second-order loss function values of the plurality of first primary parameter sets comprehensively to obtain the first loss function value, and selecting the first primary parameter set corresponding to the first loss function value as the first model parameter set.

Further, the method further comprises: acquiring first input image data corresponding to the first model parameter set; removing the fully-connected layer of the weakly supervised learning model to form a feature extraction model, extracting the feature vectors of the first input image data according to the first model parameter set to form a learning feature sequence; dividing the learning feature sequence into a second training set and a second validation set according to a preset ratio; constructing a recurrent neural network to form and load a long short-term memory learning model, calling an activation function to perform traversal inference on a plurality of second training images in the second training set, and outputting a plurality of training inference probability values corresponding to a plurality of training sub-region image data in the second training images; sorting the training sub-region image data in descending order according to the training inference probability values, screening a preset number of high-ranking training sub-region image data to obtain second input image data; inputting the second input image data and corresponding preset diagnostic classification labels of the second training images into the long short-term memory learning model, training to obtain a second primary parameter set, calculating the binary cross-entropy between the training inference probability values and the diagnostic classification labels as a first-order loss function of the second primary parameter set, and updating the long short-term memory learning model with the second primary parameter set; loading the long short-term memory learning model under the second primary parameter set, performing traversal inference on a plurality of second validation images in the second validation set, and outputting a plurality of validation inference probability values corresponding to a plurality of validation sub-region image data in the second validation images; screening the plurality of validation inference probability values to obtain the maximum validation inference probability value as the comprehensive inference probability value of the second validation image, and calculating the binary cross-entropy between the comprehensive inference probability value and the diagnostic classification label of the second validation image as the second-order loss function of the second primary parameter set; iteratively training and validating until the second-order loss function value converges to a preset loss interval to generate a plurality of second primary parameter sets, corresponding first-order loss function values, and corresponding second input image data; comprehensively evaluating the second-order loss function values of the plurality of second primary parameter sets to obtain a second loss function value, and taking the second primary parameter set corresponding to the second loss function value as the second model parameter set.

Further, the method specifically comprises: acquiring the intermediate feature sequence to form a plurality of nodes; calculating a forget gate output value by performing sigmoid activation according to a forget gate weight matrix, current node value, output value of the previous node hidden layer, and forget gate bias vector; calculating a node update value by performing sigmoid activation according to an input gate weight matrix, current node value, output value of the previous node hidden layer, and input gate bias vector; calculating a candidate state update value by performing tan h activation according to a candidate state weight matrix, current node value, output value of the previous node hidden layer, and candidate state bias vector; calculating a current node state value according to the forget gate output value, previous node state value, node update value, and candidate state update value; calculating an output gate output value by performing sigmoid activation according to an output gate weight matrix, current node value, output value of the previous node hidden layer, and output gate bias vector; performing tan h activation on the current node state value and calculating the output value of the current node hidden layer according to the activated node state value and output gate output value; using the output value of the hidden layer as the final probability value of the intermediate feature sequence and outputting it.

In an embodiment of the present invention, a digestive system pathology image identification system is provided, comprising a data acquisition module, a first-order neural network, and a second-order neural network, wherein the data acquisition module is used to acquire image data to be tested, the first-order neural network is configured as a convolutional neural network to form and load a first learning model, and to perform regional traversal prediction on the image data to be tested with a first model parameter set, so as to obtain a plurality of predicted probability values corresponding to a plurality of sub-region image data; screening the sub-region image data whose predicted probability values meet the preset assessment condition, to form an intermediate image data set, and extracting feature vectors of the intermediate image data set according to the first model parameter set to form an intermediate feature sequence; the second-order neural network is configured as a recurrent neural network to form and load a second learning model, perform traversal prediction on the intermediate feature sequence with a second model parameter set, and generate and output predicted sub-region image data and the final probability value of the predicted sub-region image data according to the sub-region image data of which the final probability value meets preset output condition.

In an embodiment of the present invention, a computer storage medium is provided, on which a computer program is stored. When the computer program is executed by a processor, the digestive system pathology image recognition method as described in any of the above technical solutions is implemented.

The digestive system pathology image recognition method provided by the present invention offers significant improvements as compared to the prior art. By sequentially loading learning models formed by convolutional neural networks (CNN) and recurrent neural networks (RNN), the method conducts two stages of classification processing on the image data to be tested. The input data for the RNN is formed by screening and sorting multiple prediction probability values obtained from the CNN. This approach allows for error checking using sequence feature coherence, thereby enhancing the accuracy of recognition and classification, effectively assisting medical professionals in making pathological diagnosis. Additionally, the CNN is front-positioned while the RNN is back-positioned. The CNN constructs a weakly supervised learning model, which can control the amount of input data for the model. RNN employs a long short-term memory model. It alleviates the long-term dependency issues compared to traditional RNNs.

### BRIEF DESCRIPTION OF THE DRAWINGS

FIG. 1 is a schematic view of the structure of a digestive system pathology image recognition system according to one embodiment of the present invention.

FIG. 2 is a schematic diagram of the steps of a digestive system pathology image recognition method according to a first embodiment of the present invention.

FIG. 3 is a schematic diagram of the steps of the digestive system pathology image recognition method according to a second embodiment of the present invention.

FIG. 4 is a schematic diagram of the first embodiment of step 31 of the digestive system pathology image recognition method according to one embodiment of the present invention.

FIG. 5 is a schematic diagram of the steps of a specific embodiment of step 311 in FIG. 4.

FIG. 6 is a schematic diagram of the steps of a specific embodiment of step 3115 in FIG. 5.

FIG. 7 is a schematic diagram of the second embodiment of step 31 of the digestive system pathology image recognition method according to one embodiment of the present invention.

FIG. 8 is a schematic diagram of the steps of the digestive system pathology image recognition method according to a third embodiment of the present invention.

FIG. 9 is a schematic diagram of a specific embodiment of step 21 of the digestive system pathology image recognition method according to one embodiment of the present invention.

FIG. 10 is a schematic diagram of a specific embodiment of step 22 of the digestive system pathology image recognition method according to one embodiment of the present invention.

FIG. 11 is a schematic diagram of a specific embodiment of step 34 of the digestive system pathology image recognition method according to one embodiment of the present invention.

### DETAILED DESCRIPTION

The present invention will be described in detail below with reference to the accompanying drawings and preferred embodiments. However, the embodiments are not intended to limit the invention, and the structural, method, or functional changes made by those skilled in the art in accordance with the embodiments are included in the scope of the present invention.

It should be noted that, the terms “include”, “comprise” or any other variant thereof are intended to cover non-exclusive inclusion, so that a process, method, article or device that includes a series of elements includes not only those elements but also other elements that are not explicitly listed or further includes the elements inherent to such process, method, article or device. In the present invention, terms “first” and “second” etc., are only used for descriptive purposes and should not be understood as indicating or implying relative importance.

The digestive system is one of the eight major systems of the human body, and its internal diseases have the nature of prominent symptoms but unclear signs. Therefore, the examination and judgment of digestive system diseases, especially the diagnosis of common digestive tract malignancies (such as gastric cancer) in today's society, is a key issue of concern in the medical field. In the diagnostic investigation process of malignant tumors of the digestive system, biopsy based histopathological section examination is an indispensable step and diagnostic criterion. How to avoid the examination efficiency being completely limited by the number and experience of pathologists, and achieve the full utilization of Computer Aided Diagnosis (CAD) related technologies to make pixel-level determinations on lesion area location information in pathology images is a technical problem that urgently needs to be solved in this field, and it is also one of the purposes of the present invention.

In order to solve the above technical problems and potential or related other problems, one embodiment of the present invention provides a computer storage medium, which is set in a computer and stores a computer program. The computer storage medium may be any available medium that the computer may access, or it may be a storage device such as a server, data center, etc., containing one or more available media integrated. The usable medium may be a magnetic medium such as a floppy disk, a hard disk, a magnetic tape, etc., or an optical medium such as a Digital Video Disc (DVD), or a semiconductor medium such as a Solid State Disk (SSD). The computer program, when executed by any processor in a computer, implements a digestive system pathology image recognition method, to execute at least: acquiring image data to be tested, constructing a convolutional neural network, forming and loading a first learning model, screening sub-region image data, forming an intermediate feature sequence, constructing a recurrent neural network, forming and loading a second learning model, generating and outputting predicted sub-region image data, and generating and outputting final probability values.

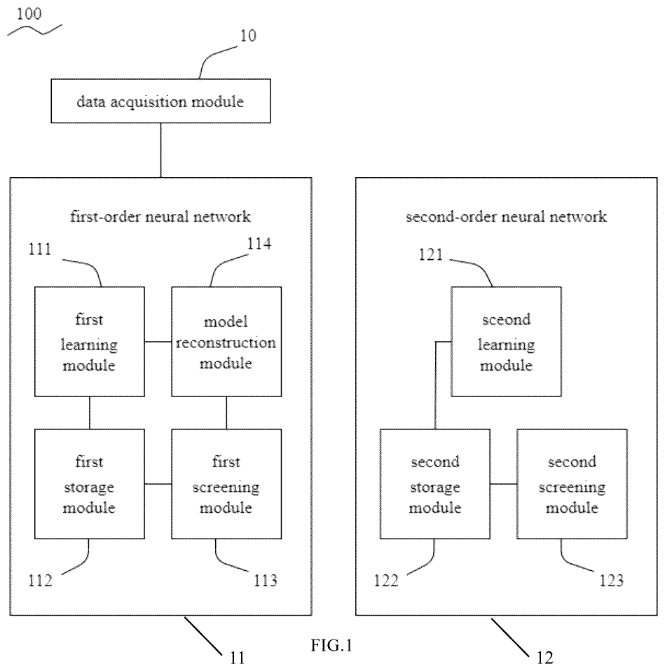

In one embodiment of the present invention, a digestive system pathology image recognition system 100 as shown in FIG. 1 is further provided. The digestive system pathology image recognition system 100 comprises a data acquisition module 10, a first-order neural network 11, and a second-order neural network 12. The data acquisition module 10 is used to acquire the image data to be tested, the first-order neural network 11 is used to construct a convolutional neural network and perform first-order processing of the relevant data, and the second-order neural network 12 is used to construct a recurrent neural network and perform second-order processing of the relevant data. The modules in the present invention are computer programs stored in the computer storage medium, and can be executed by any processor in the computer.

Specifically, the first-order neural network 11 is preferably configured as a convolutional neural network, which may comprise or consist of a first learning module 111, a first storage module 112, a first screening module 113, and a model reconstruction module 114. The second-order neural network 12 is preferably configured as a recurrent neural network, which may specifically comprise or consist of a second learning module 121, a second storage module 122, and a second screening module 123. The first learning module 111 is used to form and load the first learning model, call a first model parameter set stored in the first storage module 112 to execute regional traversal prediction on the image data to be tested, so as to obtain a plurality of predicted probability values corresponding to a plurality of sub-region image data and storing them in the first storage module 112.

The first screening module 113 is used to screen the predicted probability values stored in the first storage module 112, so as to obtain corresponding sub-region image data that meets the preset evaluation criteria, and form an intermediate image data set. The model reconstruction module 114 is used to perform model reconstruction according to the first model parameter set to generate a feature extractor, and extract the feature vectors of the intermediate image data set using the feature extractor to form an intermediate feature sequence. Preferably, the model reconstruction module 114 may further be used to perform reconstruction of the first learning model carried by the first learning module 111, to generate a feature extractor carrying the first model parameter set. Alternatively, the first screening module 113 and the model reconstruction module 114 may also be set independently of the first-order neural network 11 and the second-order neural network 12, as long as the modules with data exchange are configured to have a connection relationship to achieve the expected technical effect.

The second learning module 121 is used to form and load the second learning model, to call the second model parameters stored in the second storage module 122, and perform traversal prediction on the intermediate feature sequences output by the model reconstruction module 114 (or, alternatively, the intermediate feature sequences relaying stored in the second storage module 122), to obtain a plurality of final probability values corresponding to a plurality of sub-region image data, and store them in the second storage module 122. The second screening module 123 is used to screen the final probability values stored in the second storage module 122, to obtain the corresponding sub-region image data that meets the preset output conditions, and generate and output the predicted sub-region image data and the final probability values corresponding to the predicted sub-region image data.

Alternatively, the digestive system pathology image recognition system 100 provided by the present invention may also be configured to comprise a pre-processing module and/or a model training module. The pre-processing module may be configured to be arranged between the data acquisition module 10 and the first-order neural network 11, and is used to obtain any kind of image data (such as original image data or training image data), and perform at least one of the steps of magnification standardization, color transfer standardization, image matrix segmentation screening, etc., on the image data to generate a plurality of sets of processed image data (such as image data to be tested or sample image data).

The training module of the model may be configured to be arranged between the data acquisition module 10 and the first-order neural network 11, and connected respectively to the first-order neural network 11 and the second-order neural network 12. Alternatively, in an embodiment where the digestive system pathology image identification system 100 with a pre-processing module, the model training module may be further configured to be arranged between the pre-processing module and the first-order neural network 11. The model training module may be further configured to establish a training set and a validation set according to either learning image data or sample image data, import the training set and the validation set into the first-order neural network 11 and/or the second-order neural network 12 to perform iterative training in sequence or respectively, calculate the optimal first model parameter set and second model parameter set according to the evaluation data such as the inference accuracy of the first-order neural network 11 and the second-order neural network 12, and store them.

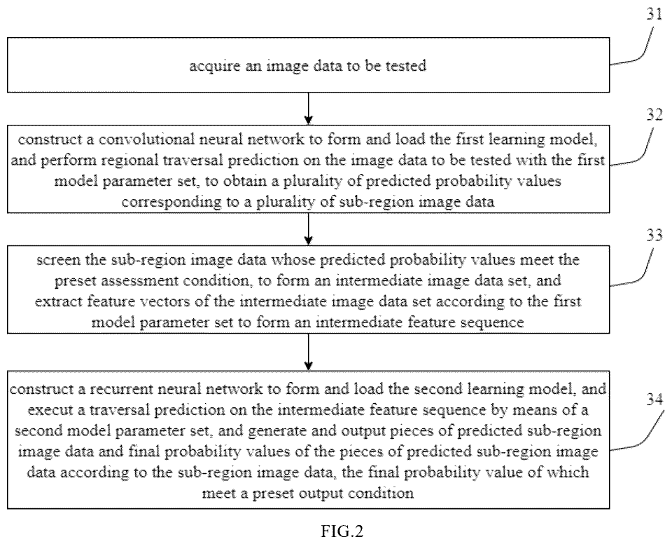

As shown in FIG. 2, the first embodiment of the present invention provides a digestive system pathology image recognition method. The corresponding program or instructions for the method may be loaded onto the computer storage medium and/or the digestive system pathology image recognition system 100 to achieve the technical effect of recognizing digestive system pathology images. The method may specifically comprise the following steps.

Step 31, acquiring image data to be tested.

The image data to be tested may refer to a plurality of sets of digestive system pathology images generated after pathological detection, or it may refer to one of the above-mentioned a plurality of sets of digestive system pathology images. The digestive system pathology images may be input as image data to be tested either in the form of image matrix data or as standard image files. The pathological regions contained in the digestive system pathology images may be processed by staining to enable complete or subtle differentiation between diseased and non-diseased areas according to color intensity. The pathological regions may also be processed in other ways to enable complete or subtle differentiation between diseased and non-diseased areas according to differences in grayscale, depth, special pixel distribution, and other factors. The image data to be tested may be generated according to adjustments of size, color, and region area according to the digestive system pathology images; alternatively, it may also be generated according to format conversion of the digestive system pathology images, or according to the original content of the digestive system pathology images without conversion. Preferably, the pathological regions are subjected to uniform, clear staining with no obvious blemishes. Preferably, the digestive system pathology images are formatted as *.svs and/or *.kfb.

Step 32, constructing a convolutional neural network to form and load the first learning model, and performing regional traversal prediction on the image data to be tested with the first model parameter set, to obtain a plurality of predicted probability values corresponding to a plurality of sub-region image data.

The regional traversal prediction, may be performed by the first learning model in the convolutional neural network or other structures, after being divided according to a preset step size, sliding window, or segmentation template, and then region-by-region traversal prediction. It may also be that the above structure directly receives image data divided according to the preset step size, sliding window, or segmentation template, and then performs region-by-region traversal prediction. In the latter technical solution, it is possible to selectively or sequentially traverse according to relative positional data (such as coordinates) of each sub-region, or to actively number a plurality of sub-regions of a single set of image data and traverse in the order of the numbers.

The convolutional neural network typically consists of an input layer, hidden layers, and an output layer. The hidden layers may specifically comprise at least one convolutional layer, at least one pooling layer, and at least one fully-connected layer. The input layer is used to receive the image data to be tested, and is preferably used to normalize the pixel values in the image matrix to enhance the processing efficiency of the convolutional neural network.

The convolutional layer is used for extracting features from the image data. The convolutional layer may comprise a plurality of neurons, a plurality of receptive fields, and activation functions, to perform at least one of linear convolution, tiled convolution, deconvolution, and dilated convolution through convolution kernels. Padding steps may be performed before passing through the convolutional kernel to counteract the size reduction of the image data during the convolution process. Specific padding methods may comprise zero padding, replication padding, valid padding, same/half padding, full padding, and arbitrary padding.

The pooling layer is used for feature selection and information screening, including predefined single or a plurality of pooling functions for performing at least one of Lp pooling, stochastic/mixed pooling, and spectral pooling. In one embodiment, the convolutional layer and the pooling layer may be configured to have a plurality of convolutional layers and pooling layers stacked to form hidden layers constructing an Inception module. The Inception module may further be set with bottleneck layers to simplify computations for achieving lightweight convolutional neural networks built with depthwise separable convolutions.

The fully-connected layer is used to classify and transmit the features extracted and filtered from the aforementioned structure, specifically through nonlinear combinations. In some embodiments, the fully-connected layer may be replaced with global average pooling. The output layer further utilizes a logic function or a standardization exponential function for the output of the label classification, and/or the output of the coordinates of the object center, size, and classification.

In this embodiment, according to the above convolutional neural network architecture, a trained learning paradigm is employed to form and load a first learning model. The first learning model may be loaded with a trained and optimized first model parameter set, and traverse the input layer to predict the image data to be tested received, outputting the classification results as probability values corresponding to the predicted probability values of the sub-region image data. The predicted probability value may be presented in percentage form, with a value range of [0%, 100%]; or in decimal form, with a value range of [0, 1]. The number of significant figures to be retained may be adjusted according to the needs of those skilled in the art.

Step 33, screening the sub-region image data whose predicted probability values meet the preset assessment condition, to form an intermediate image data set, and extracting feature vectors of the intermediate image data set according to the first model parameter set to form an intermediate feature sequence.

In order to improve the accuracy of prediction, the present invention enhances the generalization recognition effect by subjecting the image data to be tested to two rounds of neural network screening and classification. Between the two neural network processes, it is necessary to evaluate and select sub-region image data according to the predicted probability values output by the convolutional neural network, and then input the selected sub-region image data into the recurrent neural network for reclassification prediction.

The meaning of screening the sub-region image data according to predicted probability values may comprise: obtaining a preset probability threshold, determining if the predicted probability value is greater than or equal to the preset probability threshold; if so, extracting the sub-region image data corresponding to the predicted probability value and adding it to the intermediate image data set (preferably, the preset probability threshold is 0.5 or 50%, extracting sub-region image data corresponding to positive class predicted probability values greater than or equal to the preset probability threshold for further screening). It may also comprise: acquiring a preset processing quantity value, arranging the sub-region image data in descending order according to the predicted probability values (which may be explained as: extracting several sub-region image data with high predicted probability values as elements of the intermediate image data set), and screening from high to low the high-ranking sub-region image data of the preset processing quantity (preferably 5) to add to the intermediate image data set. In one embodiment, the evaluation condition is: the predicted probability value is greater than or equal to a preset probability threshold, and when sorted in descending order, it is positioned at a high rank.

The first learning model described above is loaded with the first model parameter set and achieves regional prediction. At this point, a feature extractor may be formed according to the same model parameter set to extract features from the intermediate image data set formed through the above screening process, thereby avoiding the problem of prediction results being biased or feature extraction being inaccurate due to a plurality of model parameter sets. Alternatively, the first model parameter set mentioned above may be trained and optimized as described earlier, or it may be initialized as automatically generated model parameters.

The above feature extractor may be formed by processing with the first learning model, or may be set independently of the first learning model and loaded with the first model parameter set. For the former, the method may further comprise: removing the fully-connected layer of the first learning model to form a feature extraction model, and extracting feature vectors of the intermediate image data set according to the first model parameter set to form an intermediate feature sequence.

Alternatively, step 33 is intended to describe a screening and feature extraction process, and the present invention is not limited to specific input and output data formats. For example, the intermediate feature sequence may be in various data forms such as matrices, vectors, etc., as long as it may be received and processed by a recurrent neural network.

Step 34, constructing a recurrent neural network to form and load the second learning model, and executing a traversal prediction on the intermediate feature sequence by means of a second model parameter set, and generating and outputting pieces of predicted sub-region image data and final probability values of the pieces of predicted sub-region image data according to the sub-region image data, the final probability value of which meet a preset output condition.

The step 34 may serve as a supplementary screening process for step 32 and step 33. This is because a simple convolutional neural network or its comprised first learning model may lead to recognition errors of sub-region image data due to poor image quality of the test image (such as the presence of local stains or image blurring). If the data generated by step 32 and step 33 are directly used for output, it would increase the probability of misidentification. Due to the misidentified sub-region image data belonging to a small number of challenging cases in the image data to be tested (e.g., challenging cases may be confirmed through Model Arts platform) or outliers, their impact may be excluded by the consistency of sequential features with high confidence regions. The high confidence region refers to several sub-regions with high cancer prediction probabilities (i.e., predicted probability values). Based on this, in step 34, the sub-region image data may be arranged according to the predicted probability values, and the sub-region image data with the maximum predicted probability values may be extracted; since these sub-region image data theoretically may present similar sequence features, the similarity on their sequence features (i.e., the coherence of said sequence features) may be utilized for error checking, overcoming the impact of incorrectly identified sub-region image data in the previous steps on the overall determination.

Specifically, the intermediate feature sequence may comprise one or more sets. In the case of a plurality of sets, the second learning model is configured for traversal prediction on the intermediate feature sequences in a plurality of sets using the second model parameter set. The intermediate feature sequences may be input into the second learning model as input data for prediction in sequence according to the descending order after sorting in the previous steps, to obtain the final probability value.

The second learning model may be configured with a plurality of learning paradigms, different learning paradigms may have different structures, the same or different structures may form the same or different algorithms, different algorithms have the same or different optimization methods and function configurations built in. For example, learning paradigms may comprise supervised learning and unsupervised learning. The supervised learning may involve Teacher Forcing, Backpropagation Through Time (BPTT), and Real-Time Recurrent Learning (RTRL) architectures. The algorithm may comprise algorithms for Simple Recurrent Network (SRN), such as gate control algorithms for Gated Recurrent Unit networks (GRU), deep algorithms for Stacked Recurrent Neural Network (SRNN) and Bidirectional Recurrent Neural Network (BRNN), and extension algorithms such as external memory. Optimization methods may comprise gradient clipping, regularization, Layer standardization (LN), reservoir computing, skip connection, leaky unit, and gated unit.

In this embodiment, according to the above recurrent neural network architecture, a trained algorithm is deployed to form and load the second learning model. The second learning model may be loaded with a trained and optimized second model parameter set to traverse predict the input intermediate feature sequence, and output the classification result in the form of probability values corresponding to the final probability value of the corresponding intermediate feature sequence (also known as the corresponding predicted sub-region image data). The final probability value may have the same or similar configuration as the previously predicted probability value. The preset output condition may be: the final probability value is greater than or equal to the preset probability threshold value. Further, setting the preset probability threshold to 0.5 or 50%, so that the final probability value of being classified as a positive class prediction and the corresponding predicted sub-region image data are output together. Thus, pathologists can intuitively understand the location and probability of lesion occurrence.

It may be seen that the image data to be tested goes through two-stage prediction and screening steps in sequence, which may have stronger generalization recognition ability; by the mutual cooperation of the two-stage neural networks, processed sequentially, it may reduce the amount of input image data required, balance the long-term dependency and weak thinking ability of the algorithm, and improve the prediction accuracy and screening scientificity.

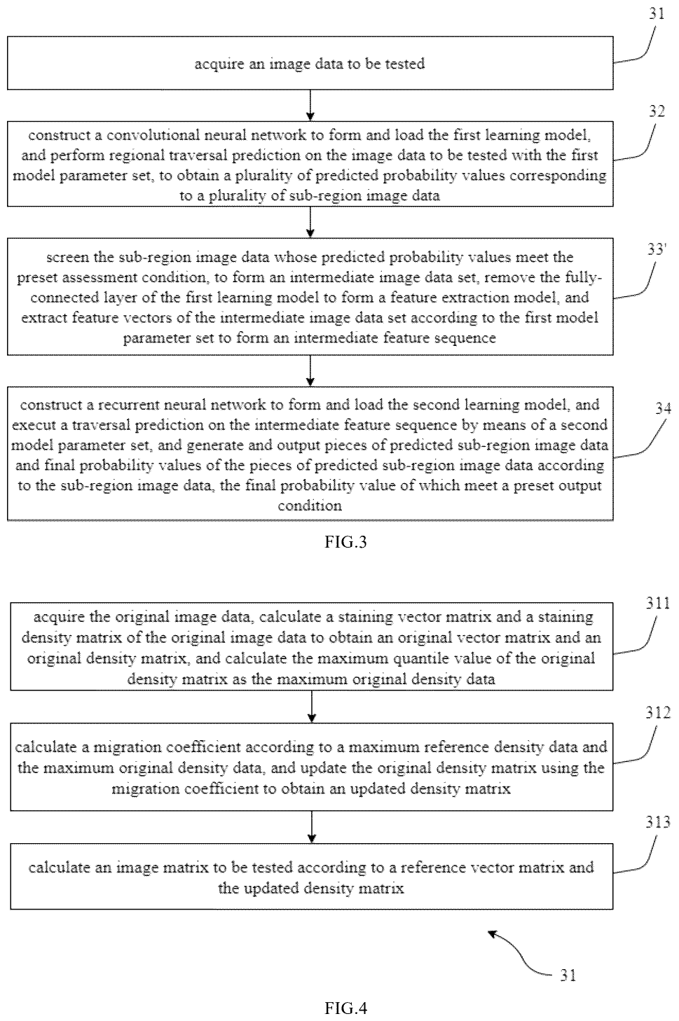

The second embodiment of the present invention provides a refined digestive system pathology image recognition method, as shown in FIG. 3, which may comprise the following steps.

Step 31, acquiring image data to be tested.

Step 32, constructing a convolutional neural network to form and load the first learning model, and performing regional traversal prediction on the image data to be tested with the first model parameter set, to obtain a plurality of predicted probability values corresponding to a plurality of sub-region image data.

Step 33′, screening the sub-region image data whose predicted probability values meet the preset assessment condition, to form an intermediate image data set, removing the fully-connected layer of the first learning model to form a feature extraction model, and extracting feature vectors of the intermediate image data set according to the first model parameter set to form an intermediate feature sequence.

Step 34, constructing a recurrent neural network to form and load the second learning model, and executing a traversal prediction on the intermediate feature sequence by means of a second model parameter set, and generating and outputting pieces of predicted sub-region image data and final probability values of the pieces of predicted sub-region image data according to the sub-region image data, the final probability value of which meet a preset output condition.

In one embodiment, the first learning model may be specifically configured as a weakly supervised learning model, and the second learning model may be specifically configured as a Long Short-Term Memory (LSTM) learning model.

The weakly supervised learning model may be configured as one of incomplete supervision, inexact supervision, and inaccurate supervision. In one embodiment, it may be specifically configured for inexact supervision, with whole image data having image-level labels (which may be in the form of several groups of labeled bags, each bag having a plurality of instances, i.e., the model as a whole is a Multiple Instance Learning), dividing the entire image data into a plurality of sub-regions for separate inference. After obtaining object-level labels, using the trained learning model at this time to achieve precise labeling of the entire image data to be tested and probability prediction of sub-regions. Alternatively, when loaded with incomplete supervision, model training may be carried out through two methods: active learning and semi-supervised learning; when loaded with inaccurate supervision, model training may be carried out through noisy learning.

The long short-term memory learning model may be configured as a general type or a variant type. General types may comprise: steps of structure definition, variable declaration, all-zero initialization, loss function definition, maximum sequence length definition, current input acquisition, previous time step state acquisition, structure output, state update, fully-connected layer output, loss calculation. The variant types may comprise the bidirectional recurrent neural network and the deep recurrent neural network mentioned above, which may be implemented through the Multi-RNN-Cell class for the forward propagation process, using zero_state to obtain the initial state. By utilizing this non-linear model, it is possible to handle and predict data with features such as intervals and long delays in time series.

In step 33′, the solution of removing the fully-connected layer of the first learning model to construct a feature extraction model, is a embodiment of the present invention, which may maintain the consistency of pre- and post-processing steps and achieve better feature extraction results. Convolutional neural networks typically have fully-connected layers, it may be understood that there is no absolute correlation between the configuration of step 33′ and whether the first learning model is configured as a weakly supervised learning model and/or the second learning model is configured as a long short-term memory learning model. However, step 33′ cooperates with the above model configuration to achieve more significant effects.

Further, step 31 provided by any of the above embodiments may further specifically comprise: acquiring an original image data, performing color transfer standardization on the original image data according to the staining situation to make the original image data have a consistent staining display, correspondingly generating an image matrix to be tested; using the image matrix to be tested as the image data to be tested.

In this way, it is possible to significantly improve the adaptability and generalization recognition ability of the model. Alternatively, optimizations made for the staining situation of the original image that are sufficient to achieve the above technical effects may be summarized as the above process. The image matrix to be tested may also be directly used as the image data to be tested for the subsequent probability prediction step, or it may be further processed to generate the image data to be tested for continued execution.

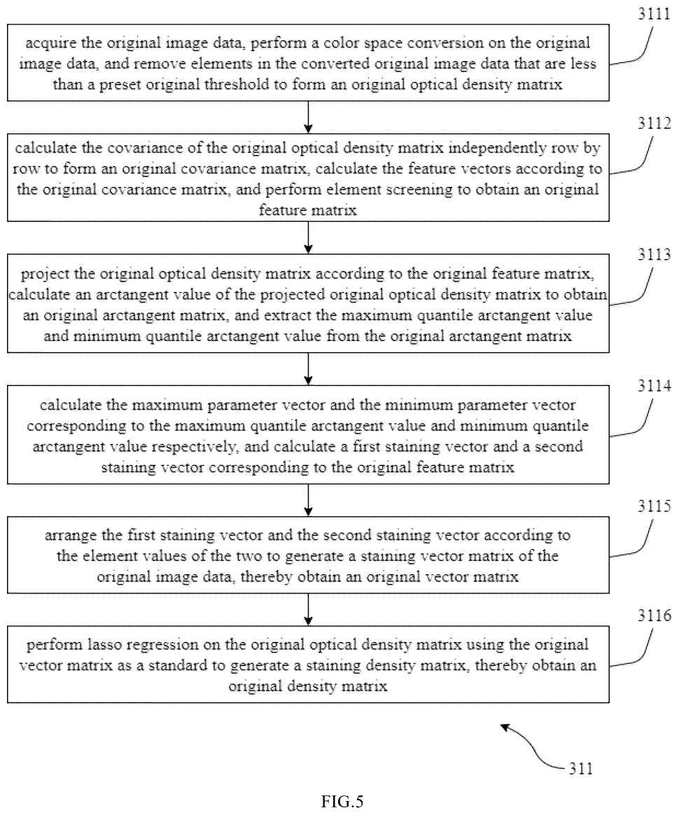

In one embodiment, for step 31 of the above process, as shown in FIG. 4, the present invention provides a first embodiment, which may comprise the following steps.

Step 311, acquiring the original image data, calculating a staining vector matrix and a staining density matrix of the original image data to obtain an original vector matrix and an original density matrix, and calculating the maximum quantile value of the original density matrix as the maximum original density data.

Step 312, calculating a migration coefficient according to a maximum reference density data and the maximum original density data, and updating the original density matrix using the migration coefficient to obtain an updated density matrix.

Step 313, calculating an image matrix to be tested according to a reference vector matrix and the updated density matrix.

Wherein, the reference vector matrix is a staining vector matrix of at least one set of high-staining-quality image data, and the maximum reference density data is the maximum quantile value of the staining density matrix of the high-staining-quality image data. Further, the criteria for evaluating the high or low quality of staining in this embodiment may comprise: uniform color representation, no fading or over-darkening of colors. The original image data may be specimen image data produced by staining with Hematoxylin-Eosin Staining (H&E staining).

The image data after staining is usually composed of the product of its staining vector matrix and staining density matrix, and the original image data in this embodiment is configured to be composed of the product of the original vector matrix and original density matrix. To achieve color consistency, the original vector matrix and original density matrix can be obtained by analysis. According to a standard, the original density matrix is updated to normalize the overall color intensity of the image. The original vector matrix is then replaced with the colored vector matrix under this standard (such as the aforementioned reference vector matrix), thereby achieving the technical effect.

The maximum quantile value mentioned above may have varying degrees of definition according to different accuracy requirements. In this embodiment, the original density matrix may be configured with the 99th percentile value per column as the maximum original density data, and the benchmark density matrix corresponding to the benchmark vector matrix may be configured with the 99th percentile value per column as the maximum benchmark density data. Based on this, the above method may further specifically comprise: calculating the 99th percentile value of the original density matrix as the maximum original density data by column; calculating the 99th percentile value of the benchmark density matrix corresponding to the benchmark vector matrix as the maximum benchmark density data by column. The reference density matrix is the density matrix corresponding to at least one set of high staining quality image data as defined by the reference vector matrix.

If the original vector matrix is defined as M_{raw}, the original density matrix as C_{raw}, the maximum original density data as C_{raw}^{max}, the maximum reference density data as C_{base}^{max}, the migration coefficient as α, the updated density matrix as C_{new}, and the image matrix to be tested as A, they must satisfy at least:

$$α = \frac{{C}_{base}^{max}}{{C}_{raw}^{max}} ;$$

$${C}_{new} = α * {C}_{raw} ;$$

$$A = {C}_{new} \cdot {M}_{base} .$$

On this basis, the image matrix to be tested A may be further mapped to the RGB space, and the mapped matrix may be used as the output image matrix to be tested for subsequent processing steps. If the image matrix to be tested after RGB mapping is defined as norm, it must satisfy at least:

$$norm = 255 * exp ( - 1 * A ) = 255 * exp ( - 1 * ( {C}_{new} \cdot {M}_{base} ) ) .$$

The step 311 provided in any one of the above technical solutions (e.g., replacing steps 31 in the embodiment shown in FIG. 2 with steps 311 to 313 to form a new embodiment as described above, and/or replacing step 31 in the embodiment shown in FIG. 3 with steps 311 to 313 to form a new embodiment as described above, the same below) may further comprise: acquiring an original image data, performing a color space conversion on the original image data to generate an original optical density matrix; projecting the original optical density matrix onto the plane where the original feature matrix is located, screening out elements representing the main staining features to generate a staining vector; rearranging the staining vector matrix of the original image data according to the element values in the staining vector to obtain an original vector matrix; compressing and estimating the original optical density matrix according to the original vector matrix to generate a staining density matrix, and obtain the original density matrix. Alternatively, the above reference vector matrix and reference density matrix may also be obtained by performing the above steps on high-quality staining image data.

Based on this, as shown in FIG. 5, in one specific embodiment, step 311 may further specifically comprise the following steps.

Step 3111, acquiring the original image data, performing a color space conversion on the original image data, and removing elements in the converted original image data that are less than a preset original threshold to form an original optical density matrix.

The original image data undergoes space conversion, which may be a conversion from RGB space to Optical Density (OD) space, or from another space to Optical Density space. In one embodiment, the preset original threshold value used for screening element values after conversion may be β=0.15.

Step 3112, calculating the covariance of the original optical density matrix independently row by row to form an original covariance matrix, calculating the feature vectors according to the original covariance matrix, and performing element screening to obtain an original feature matrix.

Different staining methods correspond to different main features, which in turn correspond to different feature vectors. In the example of the hematoxylin-eosin staining method, feature vectors of different colors corresponding to hematoxylin and eosin two different dyes can be formed. After covariance calculation and feature vector calculation, the above color features are quantified into numerical values, which may then be extracted through element screening. In the embodiment of using the hematoxylin-eosin staining method, the above-mentioned element screening may be configured as: screening to extract the 3rd and 2nd elements in each feature vector to form the original feature matrix. Preferably, the original feature matrix may comprise: a first original feature matrix representing the hematoxylin staining feature, and a second original feature matrix representing the eosin staining feature, which are mutually orthogonal.

Step 3113, projecting the original optical density matrix according to the original feature matrix, calculating an arctangent value of the projected original optical density matrix to obtain an original arctangent matrix, and extracting the maximum quantile arctangent value and minimum quantile arctangent value from the original arctangent matrix.

After projecting the original optical density matrix (which may be separate) onto a 2D plane where the original feature matrices are located, in order to further enhance and quantify the color differences, the arctangent algorithm may be used to obtain the angular coordinates (or polar coordinates) of the feature vectors. Subsequently, the high quantile values and low quantile values may be determined and retained for use in the calculation of the original vector matrix. The maximum quantile arctangent value may be the 99th percentile value in the original arctangent matrix, and the minimum quantile arctangent value may be the 1st percentile value in the original arctangent matrix.

If the original optical density matrix as defined as OD, the original feature matrix as V, and the matrix generated after projection and used for performing the arctangent operation as θ, they must satisfy at least:

$$θ = V \cdot OD .$$

Step 3114, calculating the maximum parameter vector and the minimum parameter vector corresponding to the maximum quantile arctangent value and minimum quantile arctangent value respectively, and calculating a first staining vector and a second staining vector corresponding to the original feature matrix.

After calculating the maximum quantile arctangent value and minimum arctangent value that indicate the difference in staining, the original optical density matrix in the 2D plane may be restored to the optical density space according to the parameter vectors formed by the two values, thus creating a new staining vector. The original vector matrix formed according to the new staining vector may exhibit more pronounced and consistent chromatic differences.

If the original arctangent matrix resulting from performing the arctangent operation on a matrix θ as ϕ, the maximum quantile arctangent value as ϕₘₐₓ, and the minimum quantile arctangent value as ϕₘᵢₙ, then the maximum parameter vector is [cos ϕₘₐₓ, sin ϕₘₐₓ], the minimum parameter vector is [cos ϕₘᵢₙ, sin ϕₘᵢₙ], the first staining vector ν₁ and the second staining vector ν₂ are configured to meet at least:

$${v}_{1} = V \cdot [ cos {ϕ}_{min} , sin {ϕ}_{min} ] ;$$

$${v}_{2} = V \cdot [ cos {ϕ}_{max} , sin {ϕ}_{max} ] ;$$

that is, the first staining vector is the dot product of the original feature matrix and the minimum parameter vector, and the second staining vector is the dot product of the original feature matrix and the maximum parameter vector.

Step 3115, arranging the first staining vector and the second staining vector according to the element values of the two to generate a staining vector matrix of the original image data, thereby obtaining an original vector matrix.

In order to maintain the order of different staining features in the original vector matrix consistent with the original image data, and thus maintain the consistent staining effects presented by different original image data after the above processing, it is necessary to rearrange according to different staining features.

Step 3116, performing lasso regression on the original optical density matrix using the original vector matrix as a standard to generate a staining density matrix, thereby obtaining an original density matrix.

The process of solving the original density matrix according to the original vector matrix may be implemented by various methods, specifically by linear regression, polynomial regression, ridge regression, elastic net regression, and other methods. In this embodiment, preferential implementation of the Least Absolute Shrinkage and Selection Operator (LASSO) regression can improve computational efficiency through parameter selection.

Understandably, the above reference vector matrix, reference density matrix, and the steps related to color transfer standardization throughout the present invention may be interchangeably implemented in the corresponding steps mentioned earlier, without further elaboration below.

In addition, in any of the embodiments provided in the entire text of the present invention, before performing the color transfer standardization operation, it may also comprise a magnification standardization operation (i.e., the method comprises: unifying the magnification ratio to a set ratio) to avoid image up-sampling distortion. Preferably, the magnification for the collected images with magnification factors of five, ten, twenty, or forty is unified to ten times (i.e., setting the magnification factor to ten). In this process, the reading and down-sampling of images (for images with magnification factors exceeding ten times) may be done using either OpenSlide or OpenCV2 (especially the ‘resize’ operation) in Python, especially the resize operation. Understandably, the entire text of the present invention relates to the standardization of magnification factors, all of which may be interchangeably implemented in corresponding steps as described above, and will not be elaborated further below.

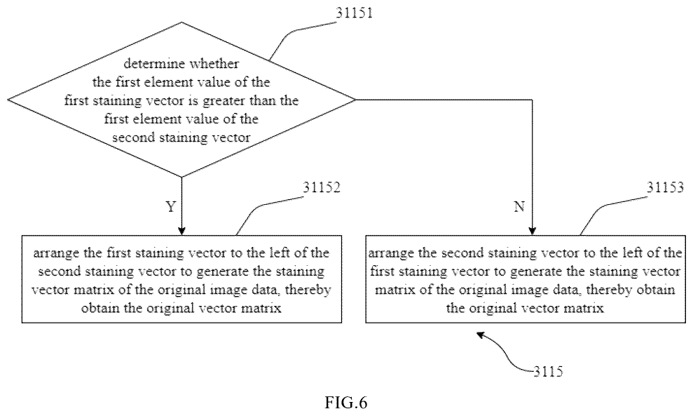

As shown in FIG. 6, the step 3115 provided by any of the above technical solutions may further specifically comprise the following steps in a specific embodiment (in particular, an embodiment using the hematoxylin-eosin staining method).

Step 31151, determining whether the first element value of the first staining vector is greater than the first element value of the second staining vector.

When the first element value of the first staining vector is greater than the first element value of the second staining vector, (step 31152) arranging the first staining vector to the left of the second staining vector to generate the staining vector matrix of the original image data, thereby obtaining the original vector matrix.

When the first element value of the first staining vector is not greater than the first element value of the second staining vector, (step 31153) arranging the second staining vector to the left of the first staining vector to generate the staining vector matrix of the original image data, thereby obtaining the original vector matrix.

Thus, elements representing the staining characteristics of hematoxylin are placed in the front, while elements representing the staining characteristics of eosin are placed at the back. If the original vector matrix is defined as M, then after executing step 31152, the following is satisfied:

M=[ν₁,ν₂].
after executing step 31153, the following is satisfied:

M=[ν₂,ν₁].

The step 31 provided in any of the above embodiments may further comprise: segmenting the image matrix to be tested by a sliding window of a preset size to obtain a plurality of sub-region image data and position data of the sub-region image data in the image matrix to be tested; analyzing and screening the tissue area ratio in the sub-region image data, and storing the sub-region image data with tissue area ratio meeting the preset condition as image data to be tested. That is, in this embodiment, the image matrix to be tested may be segmented and screened sequentially to include the sub-region image data containing more tissue content as the target for subsequent prediction. Therefore, overall efficiency is improved, unnecessary time consumption is reduced, and a plurality of object-level image data before weakly supervised learning is formed.

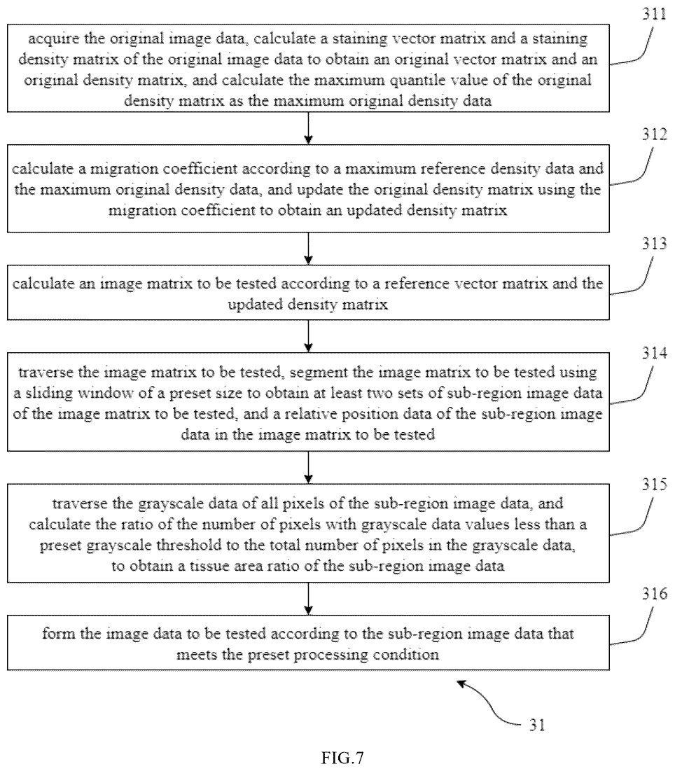

Based on this, as shown in FIG. 7, in the second embodiment thereof, step 31 may further specifically comprise the following steps.

Step 311, acquiring original image data, calculating a staining vector matrix and a staining density matrix of the original image data to obtain an original vector matrix and an original density matrix, and calculating the maximum quantile value of the original density matrix as the maximum original density data.

Step 312, calculating a migration coefficient according to maximum reference density data and the maximum original density data, and updating the original density matrix using the migration coefficient to obtain an updated density matrix.

Step 313, calculating an image matrix to be tested according to a reference vector matrix and the updated density matrix.

Step 314, traversing the image matrix to be tested, segmenting the image matrix to be tested using a sliding window of a preset size to obtain at least two sets of sub-region image data of the image matrix to be tested, and relative position data of the sub-region image data in the image matrix to be tested.

Step 315, traversing the grayscale data of all pixels of the sub-region image data, and calculating the ratio of the number of pixels with grayscale data values less than a preset grayscale threshold to the total number of pixels in the grayscale data, to obtain a tissue area ratio of the sub-region image data.

Step 316, forming the image data to be tested according to the sub-region image data that meets the preset processing condition.

The preset processing condition is: the tissue area ratio of the sub-region image data is greater than a preset ratio threshold.

The preset size is mainly determined according to the backbone models of different neural networks. In this embodiment, RegNetY-600MF is preferred as the backbone model. Based on this, the preset size may be configured as 224*224 pixels, which is the design input size of the dragon bone model. During the segmentation process, the sliding window area of the preset size may be configured to traverse horizontally and vertically with a step size of 10%-15% of its side length to obtain a series of sub-region image data and the relative position data of the sub-region image data in the image data to be tested (which may be coordinates; preferably, the coordinates may be calculated with the lower-left corner of the image data to be tested as the coordinate origin). In one embodiment, the step size may be configured as 32 pixels.

Between the step 314 and step 315, the method further comprise: converting the sub-region image data to grayscale to obtain grayscale data of all pixels of all sub-region image data. Thus, clearly and definitively determining the tissue area ratio makes it easy to remove sub-regions with excessive background areas and/or sub-regions that do not contain or contain too few organizational samples. Alternatively, grayscale conversion may be interleaved or performed together at any step before step 315, and the present invention does not limit the relative position between the grayscale conversion step and other steps.

In one embodiment, in the sub-region image data after grayscale conversion, the background will have a lighter color compared to the foreground tissue region, with correspondingly greater grayscale data. Based on this, the preset grayscale threshold may be configured to be equal to 210, so that pixels in the grayscale data with values less than 210 are determined to constitute elements of the tissue region. Further, the preset ratio threshold may be configured as 30%. Alternatively, step 315 and step 316 may also be configured as: calculating the ratio of the number of pixels in the grayscale data with values greater than or equal to a preset grayscale threshold to the total number of pixels, obtaining the ratio of the background region in the sub-region image data; forming the image data to be tested according to the sub-region image data that meets the preset processing conditions. Wherein, the preset processing condition is: the ratio of the background area of the sub-region image data is less than the preset ratio threshold; the preset ratio threshold is 70%.

Alternatively, the process of forming the image data to be tested in step 316 does not only refer to saving the sub-region image data itself, but may also be configured to save the sub-region image data and its relative position data, or configured to save undivided image data (e.g., the image matrix to be tested or original image data) and the relative position data of the sub-region image data.

For the last case, step 316 may be specifically configured as: extracting relative position data corresponding to the sub-region image data that meets preset processing conditions, and storing the relative position data and either the image matrix to be tested or original image data, or both, as the image data to be tested. Additionally, a corresponding step may be added in the subsequent operation process: segmenting the image data to be tested or the original image data according to the relative positional data to generate a plurality of sub-region image data. Thus, the data reading pressure may be reduced, avoiding storing a large amount of small-sized sub-region image data for calling.

If the relative position data of sub-region image data in the matrix of a test image is defined as: taking the bottom left corner of the image matrix to be tested as the coordinate origin, to calculate the bottom left corner coordinates of each sub-region image data. Then, the relative position data may form a set Coordsᵢₙₚᵤₜ=[(x₀, y₀), (x₁, y₁), . . . , (xₙ, yₙ)], in which (x₀, y₀), (x₁, y₁), . . . , (xₙ, yₙ) is the relative position data for different sub-region image data. If the relative position data of the i-th sub-region image data is set to be (xᵢ, yᵢ), and the side length of the sub-region image data is 1, then the coverage area of the sub-region image data may be represented as [(xᵢ, yᵢ), (xᵢ+l, yᵢ+l)].

After steps 32 and 33 (or steps 32 and 33′, as well as steps of other derivative embodiments of the above two steps), a predicted probability value set Predsᵢₙₚᵤₜ=[p₀, p₁, . . . , pₙ] may be obtained. Where, p₀, p₁, . . . , pₙ is the predicted probability value of different sub-region image data that meets the preset assessment condition.

Preferably, the predicted probability values in the set are all positive class predicted probability values (greater than or equal to 0.5 or 50%) through screening, and at high ranks after sorting in descending order (less than or equal to a preset processing quantity, preferably less than or equal to 5). Consequently, it is possible to correspondingly extract sub-region image data (or relative position data of sub-region image data) corresponding to the positive class predicted probability values. Preferably, the lower-left corner coordinates corresponding to the sub-region image data can be extracted to form an intermediate image data set Coordsᵢₙₚᵤₜ^{topk}.

After step 33 or step 33′, extracting the feature vector of the sub-region image data corresponding to each coordinate position in the intermediate image data set Coordsᵢₙₚᵤₜ^{topk}, to form an intermediate feature sequence Seq=[feat_vec₁, feat_vec₂, . . . , feat_vecₖ]. Where, feat_vec₁, feat_vec₂, . . . , feat_vecₖ is the feature vector of different sub-region image data that meet the preset assessment condition.

After step 34 or steps derived from it, the intermediate feature sequence Seq is input into the second learning model for screening and evaluation. If the final probability value generated after two evaluations is still a positive class predicted probability value, then the digestive system location represented by the image data of the predicted sub-region corresponding to that final probability value has a higher probability of lesion.

Understandably, the steps 314 to 316 added in the second embodiment may be implemented as an alternative in any of the previous technical solutions to achieve the corresponding technical effects. In other words, the second embodiment may be combined with any one or more additional steps disclosed above to correspondingly generate one or more alternative embodiments. Further, all the steps involving image matrix segmentation screening in the present invention may be interchangeably implemented in the corresponding steps described above, and will not be described in detail below.

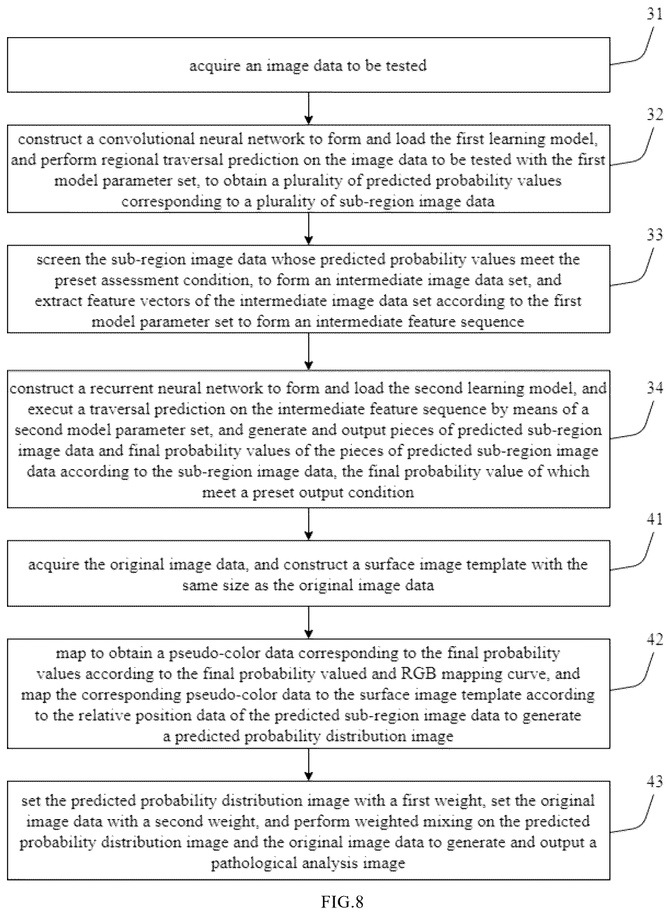

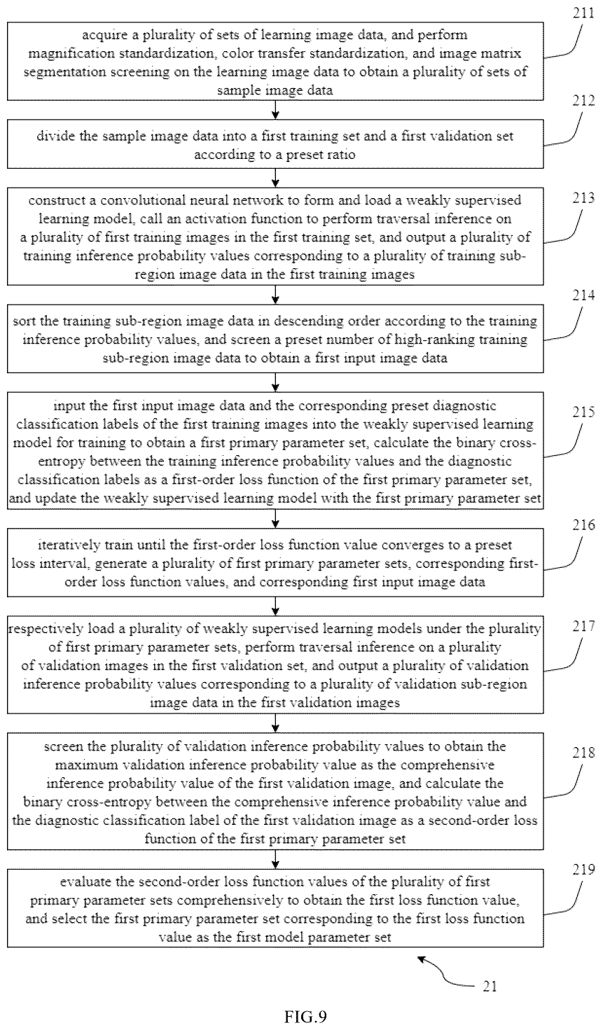

The third embodiment of the present invention provides a more refined digestive system pathology image recognition method, as shown in FIG. 8, which may comprise the following steps.

Step 31, acquiring image data to be tested.

Step 32, constructing a convolutional neural network to form and load the first learning model, and performing regional traversal prediction on the image data to be tested with the first model parameter set, to obtain a plurality of predicted probability values corresponding to a plurality of sub-region image data.

Step 33, screening the sub-region image data whose predicted probability values meet the preset assessment condition, to form an intermediate image data set, and extracting feature vectors of the intermediate image data set according to the first model parameter set to form an intermediate feature sequence.

Step 34, constructing a recurrent neural network to form and load the second learning model, and executing a traversal prediction on the intermediate feature sequence by means of a second model parameter set, and generating and outputting pieces of predicted sub-region image data and final probability values of the pieces of predicted sub-region image data according to the sub-region image data, the final probability value of which meet a preset output condition.

Step 41, acquiring the original image data, and constructing a surface image template with the same size as the original image data.

Step 42, mapping to obtain pseudo-color data corresponding to the final probability values according to the final probability values and RGB mapping curve, and mapping the corresponding pseudo-color data to the surface image template according to the relative position data of the predicted sub-region image data to generate a predicted probability distribution image.

Step 43, setting the predicted probability distribution image with a first weight, setting the original image data with a second weight, and performing weighted mixing on the predicted probability distribution image and the original image data to generate and output a pathological analysis image.

Wherein, the relative position data records the relative position of the predicted sub-region image data in the original image data, the values of the first weight and the second weight range from 0 to 1, and the sum of the first weight and the second weight is equal to 1. Thus, the effect of converting at least the lesion site into a pseudo-color image (also known as a heat-map) and overlaying it on the original image for output is achieved. Preferably, the image is output in PNG format. The pseudo-color data values increase with greater probability of the region being a lesion (or, a cancerous lesion), and decrease with less probability.

Alternatively, in one embodiment, since the sub-region image data corresponding to the final probability value is filtered by step 33, there may be a situation where the predicted sub-region image data may only cover part of the original image data, and cannot completely cover the entire original image data. Based on this, the step 42 may also be alternatively implemented by: extracting the predicted probability values that do not intersect with the final probability values, and the sub-region image data corresponding to the predicted probability value; mapping to obtain the pseudo-color data corresponding to the final probability value and the extracted predicted probability value according to the final probability value, the extracted predicted probability value, and RGB mapping curve, and mapping the corresponding pseudo-color data to the surface image template according to the relative position data of the predicted sub-region image data, to generate a predicted probability distribution image. Based on the same thinking, the step 42 may also be: mapping to obtain the pseudo-color data corresponding to the predicted probability value according to the predicted probability value and RGB mapping curve, and mapping the corresponding pseudo-color data to the surface image template according to the relative position data of the predicted sub-region image data to generate a predicted probability distribution image.

The surface image template may be a blank single-channel mask, and the above operation process may be implemented according to the apply-Color-Map function of OpenCV2, and the generated predicted probability distribution image may have the COLORMAP_JET mode. Preferably, the first weight and the second weight are both 0.5. Define the final probability value, the combination of the final probability value and the extracted predicted probability value, or the predicted probability value used for output as Predsₒᵤₜₚᵤₜ, then the region in the predicted probability distribution image corresponding to the i-th sub-region image data may satisfy at least:

$$mask [ ( {x}_{i} , {y}_{i} ) , ( {x}_{i} + l , {y}_{i} + l ) ] = {Preds}_{output}^{i} .$$

As a supplementary note, although “relative position data in the image matrix to be tested” and “relative position data in the original image data” have been defined in the previous sections, it should be understood that in the process of generating the image matrix to be tested according to the original image matrix, if there is no image size adjustment, the concepts of the two relative position data are the same; if there is image size adjustment, the concepts of the two relative position data are interrelated. In the process of overlaying images from step 41 to step 43, the relative position data corresponding to the original image data (defined as first relative position data) is used. In the iterative process of learning model, the relative position data corresponding to the image matrix to be tested (defined as second relative position data) is used, and the first relative position data and the second relative position data have a proportional conversion relationship.

Understandably, the steps 41 to 43 added in the third embodiment may be implemented as an alternative in any of embodiment may technical solutions to achieve the corresponding technical effects. In other words, the third embodiment may be combined with any one or more additional steps disclosed above to correspondingly generate one or more alternative embodiments.

The present invention provides a pre-step 21 before step 31 of any of the above technical solutions and their derivative solutions, to combine to form at least one new technical solution, as shown in FIG. 9. Step 21 may comprise the following steps in a specific embodiment.

Step 211, acquiring a plurality of sets of learning image data, and performing magnification standardization, color transfer standardization, and image matrix segmentation screening on the learning image data to obtain a plurality of sets of sample image data.

The magnification standardization is to unify the magnification factor of all learning image data, the color transfer standardization is to unify the color consistency of all learning image data and the color uniformity of the images themselves, and the matrix segmentation screening is to form a plurality of sub-region image data for subsequent traversal inference (which may refer to the sub-region image data itself, or refer to the relative position data corresponding to the sub-region image data). The above three steps and related steps may be alternatively implemented in the corresponding embodiments described above, or even combined, concatenated, or replaced to form a plurality of new embodiments, which are not further elaborated here.

Step 212, dividing the sample image data into a first training set and a first validation set according to a preset ratio.

The preferred preset ratio may be 7:3, meaning the first training set accounts for 70%, and the first validation set accounts for 30%. The dividing method is preferably dividing according to the sub-area image data to ensure that a plurality of sub-area image data constituting a single learning image data may be assigned to the same set (either the first training set or the first validation set), in order to prevent confusion in the allocation of a plurality of sub-area image data belonging to the same learning image data and having similarities, which may lead to artificially inflated validation metrics and affecting the actual effectiveness of the model. Alternatively, other embodiments may also be possible when the overall consistency of the learning image data is great.

Step 213, constructing a convolutional neural network to form and load a weakly supervised learning model, calling an activation function to perform traversal inference on a plurality of first training images in the first training set, and outputting a plurality of training inference probability values corresponding to a plurality of training sub-region image data in the first training images.

The activation function may be the softmax function or the sigmoid function.

Step 214, sorting the training sub-region image data in descending order according to the training inference probability values, and screening a preset number of high-ranking training sub-region image data to obtain first input image data.

Preferably, only the training sub-region images corresponding to the inference probability values greater than a preset probability threshold is sorted in descending order. The preset probability threshold may be set as the positive class inference probability value (greater than 0.5 or 50%). The preset quantity in one embodiment may be configured as 5.

Step 215, inputting the first input image data and the corresponding preset diagnostic classification labels of the first training images into the weakly supervised learning model for training to obtain a first primary parameter set, calculating the binary cross-entropy between the training inference probability values and the diagnostic classification labels as a first-order loss function of the first primary parameter set, and updating the weakly supervised learning model with the first primary parameter set.

The preset diagnostic classification labels may be labels included in the learning image data used for training the model input by pathologists, at least to represent whether there are lesion sites in the learning image data as a whole. Preferably, setting the learning image data containing the lesion site with label 1, and setting the learning image data without the lesion site with label 0. Alternatively, in the embodiments with supervised learning models or other models with higher levels of human intervention, the preset diagnostic classification labels may be directly for the first training image (or for the sub-region image data corresponding to the first training image, or for the sample image data corresponding to the first training image).

If defining the preset diagnostic classification label as yᵢ, the training inference probability value as p(yi), the calculated total training inference probability value (i.e., the total number of training sub-region image data) as N, in the embodiment where the first-order loss function is configured as the binary cross-entropy of the two, the first-order loss function must satisfy at least:

$${H}_{p} ( 1 ) = - \frac{1}{N} {\sum }_{i = 1}^{N} {y}_{i} \cdot log ( p ( {y}_{i} ) ) + ( 1 - {y}_{i} ) \cdot log ( 1 - p ( {y}_{i} ) ) .$$

Step 216, iteratively training until the first-order loss function value converges to a preset loss interval, generating a plurality of first primary parameter sets, corresponding first-order loss function values, and corresponding first input image data.

The model training optimizer should be preferably Adam. The preset loss interval depends on the neural network algorithm model framework itself and different data scenarios, generally having a plurality of definitions. In this embodiment, it may be defined as the first-order loss function value decreasing and stabilizing within the preset loss interval.

Step 217, respectively loading a plurality of weakly supervised learning models under the plurality of first primary parameter sets, performing traversal inference on a plurality of validation images in the first validation set, and outputting a plurality of validation inference probability values corresponding to a plurality of validation sub-region image data in the first validation images.

In the present invention, as stated in step 217, after training to obtain a plurality of first primary parameter sets, the different first primary parameter sets may be loaded collectively and separately, and validated using the first validation set (i.e., independent validation); alternatively, after training to obtain one set of first primary parameters, the set of first primary parameters may be loaded and validated using the first validation set (i.e., real-time validation). The former is suitable for scenarios with large amounts of data, while the latter is suitable for scenarios with small amounts of data, and technicians in this field may adjust according to their needs.

Step 218, screening the plurality of validation inference probability values to obtain the maximum validation inference probability value as the comprehensive inference probability value of the first validation image, and calculating the binary cross-entropy between the comprehensive inference probability value and the diagnostic classification label of the first validation image as a second-order loss function of the first primary parameter set.

Step 219, evaluating the second-order loss function values of the plurality of first primary parameter sets comprehensively to obtain the first loss function value, and selecting the first primary parameter set corresponding to the first loss function value as the first model parameter set.

The purpose of performing traversal inference on the first validation set is to select a first primary parameter set that is sufficient to optimize the inference effect from the plurality of first primary parameter sets to be the first model parameter set. The previous description mainly controls the progress of traversal inference on the first training set using a first-order loss function, and conducts preliminary performance evaluation of the corresponding first-level parameter set. It also uses a second-order loss function to perform inference on the first validation set to evaluate the general applicability of the first-level parameter set. Alternatively, a comprehensive evaluation may also be conducted by observing other indicators of the first primary parameter set. For example, on the basis of achieving a high level (e.g., exceeding 97%) of matching probability (or, inference accuracy) between the probability values of various inferences and preset diagnostic classification labels, use these probability values and preset diagnostic classification labels to create evaluation parameters such as specimen-level inference accuracy, sensitivity, and specificity, and select a set of parameters that are both highly evaluated and balanced.

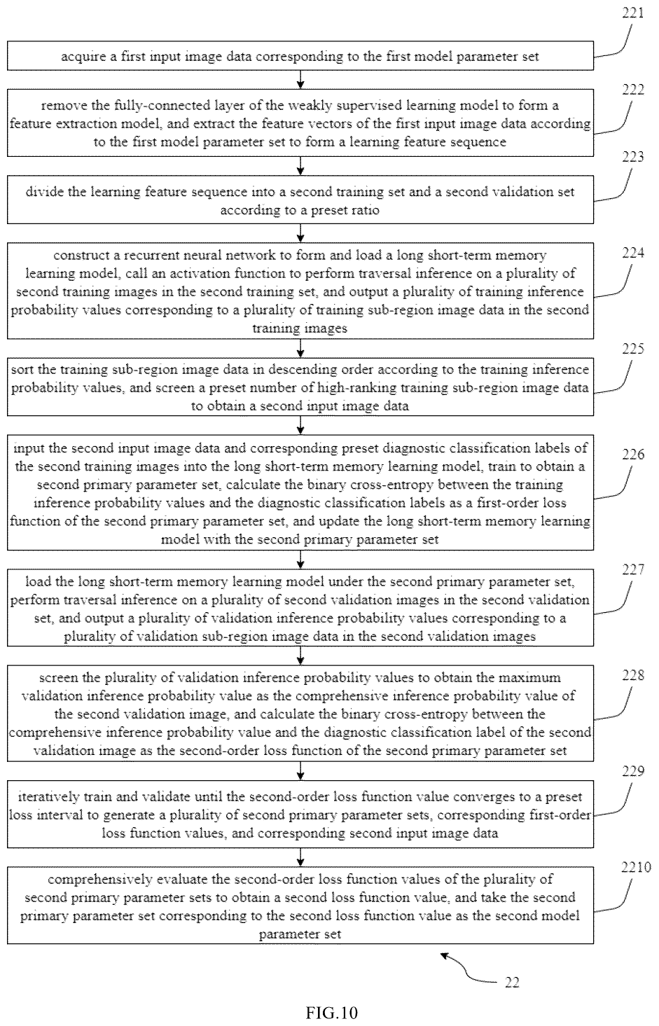

The present invention provides a pre-step 22 before step 31 of any of the above technical solutions and their derivative solutions, to combine to form at least one new technical solution, as shown in FIG. 10. Step 22 may comprise the following steps in a specific embodiment.

Step 221, acquiring first input image data corresponding to the first model parameter set.

Step 222, removing the fully-connected layer of the weakly supervised learning model to form a feature extraction model, and extracting the feature vectors of the first input image data according to the first model parameter set to form a learning feature sequence.

Step 223, dividing the learning feature sequence into a second training set and a second validation set according to a preset ratio.

Step 224, constructing a recurrent neural network to form and load a long short-term memory learning model, calling an activation function to perform traversal inference on a plurality of second training images in the second training set, and outputting a plurality of training inference probability values corresponding to a plurality of training sub-region image data in the second training images.

Based on the sequence coherence between sub-region image data with high trained inference probability values, to overcome the impact of misjudgment in convolutional neural networks especially weakly supervised learning models for the same reason, it is necessary to use the first input image data output by the previous step convolutional neural network as input for training the long short-term memory neural network. As a supplementary note, the first input image data contains a plurality of sub-region image data of a plurality of learning image data, and at least 5 sub-region image data with a high inference probability of any kind. Therefore, before performing feature sequence extraction, a portion of the input image data (which may be a preset learning quantity, such as 16 or 32) from the first input image data may be selected, or it may be divided into a plurality of sets of sub-regions of image data, each containing a preset learning quantity, to perform feature extraction and generate a learning feature sequence. The present invention is not limited to performing feature extraction and subsequent processing on all first input image data.

Thus, at least generating a set of learning feature sequences composed of s sub-region image data with a preset learning quantity s, where the learning feature sequence has a length of the preset learning quantity s and comprises a plurality of feature vectors of length p, thereby forming an s*p feature vector composition form, the node length of the constructed long short-term memory learning model may also be configured as s. Preferably, learning with a feature sequence length of s=32, feature vector length of p=608 (determined according to the RegNetY-600MF backbone model architecture), the number of hidden layers for the corresponding long short-term memory learning model is set to 128.

Step 225, sorting the training sub-region image data in descending order according to the training inference probability values, and screening a preset number of high-ranking training sub-region image data to obtain a second input image data.

Step 226, inputting the second input image data and corresponding preset diagnostic classification labels of the second training images into the long short-term memory learning model, training to obtain a second primary parameter set, calculating the binary cross-entropy between the training inference probability values and the diagnostic classification labels as a first-order loss function of the second primary parameter set, and updating the long short-term memory learning model with the second primary parameter set.

Step 227, loading the long short-term memory learning model under the second primary parameter set, performing traversal inference on a plurality of second validation images in the second validation set, and outputting a plurality of validation inference probability values corresponding to a plurality of validation sub-region image data in the second validation images.

Step 228, screening the plurality of validation inference probability values to obtain the maximum validation inference probability value as the comprehensive inference probability value of the second validation image, and calculating the binary cross-entropy between the comprehensive inference probability value and the diagnostic classification label of the second validation image as the second-order loss function of the second primary parameter set.

In the prevent invention, as described in step 227, after training to obtain a second primary parameter set, the second primary parameter set is loaded and validated using a second validation set (i.e., it may be real-time validation); Alternatively, it is also possible to uniformly and separately load different second sets of primary parameters after training to obtain a plurality of second sets of primary parameters, and validate using the second validation set (i.e., it may also be independent validation). The former is suitable for scenarios with small amounts of data, while the latter is suitable for scenarios with large amounts of data, and technical personnel in this field may adjust as needed.

Step 229, iteratively training and validating until the second-order loss function value converges to a preset loss interval to generate a plurality of second primary parameter sets, corresponding first-order loss function values, and corresponding second input image data.

Step 2210, comprehensively evaluating the second-order loss function values of the plurality of second primary parameter sets to obtain a second loss function value, and taking the second primary parameter set corresponding to the second loss function value as the second model parameter set.

In this embodiment, the training process of the long short-term memory learning model may be replaced by referring to the training process of weakly supervised learning models in terms of the division of the second training set and the second validation set, configuration of internal model functions, rules for descending order screening, definition and invocation of predefined diagnostic classification labels, selection of model training optimizers, iteration rules for second-order loss functions, and generation of parameters for the second model group. Alternatively, those skilled in the art may also attach other existing technologies to form new technical solutions that do not deviate from the concept of the present invention, such as building learning models using Pytorch and TensorFlow according to Python.

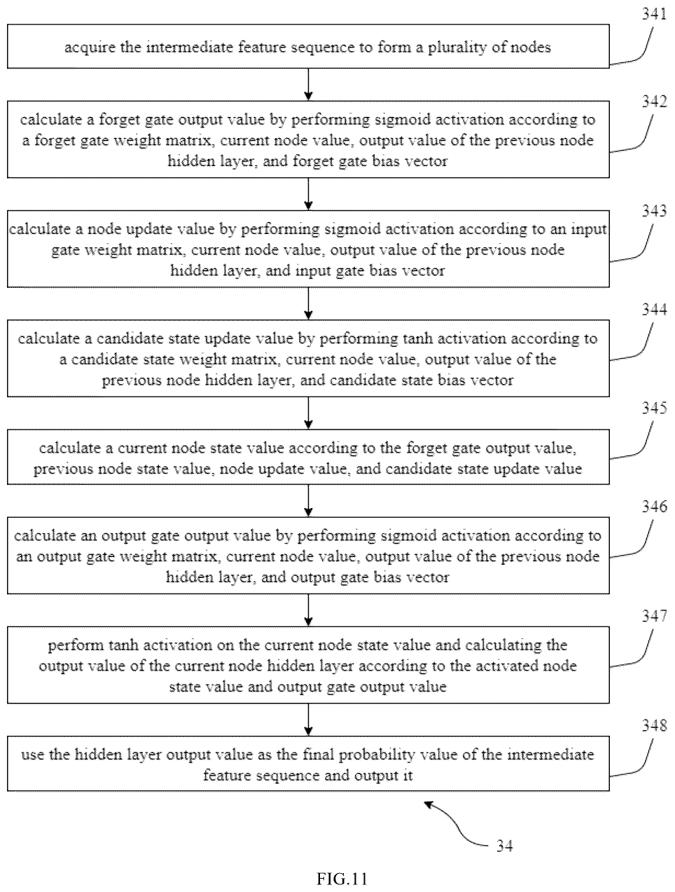

As shown in FIG. 11, the steps 34 provided in any of the above embodiments may further specifically comprise the following steps in a specific example.

Step 341, acquiring the intermediate feature sequence to form a plurality of nodes.

Step 342, calculating a forget gate output value by performing sigmoid activation according to a forget gate weight matrix, current node value, output value of the previous node hidden layer, and forget gate bias vector.

For any node t, if the output value of the forget gate is defined as fₜ, then it must satisfy at least:

$${f}_{t} = σ ( {W}_{f} \cdot [ {h}_{t - 1} , {x}_{t} ] + {b}_{f} ) ;$$

where, σ( ) represents the sigmoid activation function, W_{f} represents the forget gate weight matrix, hₜ₋₁ represents the output value of the previous node hidden layer, xₜ represents the current node value, b_{f} represents the forget gate bias vector.

Step 343, calculating a node update value by performing sigmoid activation according to an input gate weight matrix, current node value, output value of the previous node hidden layer, and input gate bias vector.

For any node t, if the node update value is defined as iₜ, then it must satisfy at least:

$${i}_{t} = σ ( {W}_{i} \cdot [ {h}_{t - 1} , {x}_{t} ] + {b}_{i} ) ;$$

where, Wᵢ is the input gate weight matrix, and bᵢ is the input gate bias vector.

Step 344, calculating a candidate state update value by performing tan h activation according to a candidate state weight matrix, current node value, output value of the previous node hidden layer, and candidate state bias vector.

For any node t, if the candidate state update value is defined as \tilde{C}ₜ, then it must satisfy at least:

$${\tilde{C}}_{t} = tanh ( {W}_{C} \cdot [ {h}_{t - 1} , {x}_{t} ] + {b}_{C} ) ;$$

where, tan h( ) represents the tan h activation function, W_{c} is the input gate weight matrix, b_{c} is the input gate bias vector.

Steps 345, calculating a current node state value according to the forget gate output value, previous node state value, node update value, and candidate state update value.

For any node t, if the current node state value is defined as Cₜ, then it must satisfy at least:

$${C}_{t} = {f}_{t} * {C}_{t - 1} + {i}_{t} * {\tilde{C}}_{t} ;$$

where, Cₜ₋₁ is the previous node state value.

Step 346, calculating an output gate output value by performing sigmoid activation according to an output gate weight matrix, current node value, output value of the previous node hidden layer, and output gate bias vector.

For any node t, if the output gate output value is defined as oₜ, then it must satisfy at least:

$${o}_{t} = σ ( {W}_{o} \cdot [ {h}_{t - 1} , {x}_{t} ] + {b}_{o} ) ;$$

where, Wₒ is the output gate weight matrix, bₒ is the output gate bias vector.

Step 347, performing tan h activation on the current node state value and calculating the output value of the current node hidden layer according to the activated node state value and output gate output value.

For any node t, if the output value of the hidden layer is defined as \tilde{C}ₜ, then it must satisfy at least:

$${h}_{t} = {o}_{t} * tanh ( {C}_{t} ) .$$

Step 348, using the output value of the hidden layer as the final probability value of the intermediate feature sequence and outputting it.

It is worth noting that in the various methods provided in the embodiments, the order of a plurality of steps included and the order of processing content within a single step may be adjusted when there is no correlation between data acquisition and utilization. The adjustment may involve swapping their order or configuring different steps to be implemented simultaneously. The order of the various unrelated steps mentioned above is not considered a necessary technical feature of the present invention.

In conclusion, the digestive system pathology image recognition method provided by the present invention sequentially loads the learning model formed by a convolutional neural network and a recurrent neural network to perform two classification processes on the image data to be tested. The input data of the recurrent neural network is selected according to the plurality of predicted probability values obtained by the convolutional neural network, allowing for further verification of misjudgment using the coherence of sequential features to improve the accuracy of recognition and classification, truly achieving the effect of assisting medical professionals in pathological diagnosis. Additionally, the convolutional neural network is front-positioned while the recurrent neural network is back-positioned. The convolutional neural network constructs a weakly supervised learning model, which can control the amount of input data for the model. When the recurrent neural network is the Long Short-Term Memory model, it may alleviate long-term dependencies compared to traditional recurrent neural networks.

It should be understood that, although the specification is described in terms of embodiments, not every embodiment merely comprises an independent technical solution. Those skilled in the art should have the specification as a whole, and the technical solutions in each embodiment may also be combined as appropriate to form other embodiments that can be understood by those skilled in the art.

The present invention by no means is limited to the preferred embodiments described above. On the contrary, many modifications and variations are possible within the scope of the appended claims.

1. A digestive system pathology image recognition method, comprising:
acquiring image data to be tested;
constructing a convolutional neural network to form and load a first learning model, and performing regional traversal prediction on the image data to be tested with a first model parameter set, to obtain a plurality of predicted probability values corresponding to a plurality of sub-region image data;
screening the sub-region image data whose predicted probability values meet a preset assessment condition, to form an intermediate image data set, and extracting feature vectors of the intermediate image data set according to the first model parameter set to form an intermediate feature sequence;
constructing a recurrent neural network to form and load a second learning model, and executing traversal prediction on the intermediate feature sequence by means of a second model parameter set, and generating and outputting pieces of predicted sub-region image data and final probability values of the pieces of predicted sub-region image data according to the sub-region image data, the final probability value of which meet a preset output condition.

2. The digestive system pathology image recognition method of claim 1, wherein the first learning model is a weakly supervised learning model, and the second learning model is a long short-term memory learning model; the method further comprising:
removing a fully-connected layer of the first learning model to form a feature extraction model, and extracting feature vectors of the intermediate image data set according to the first model parameter set to form the intermediate feature sequence.

3. The digestive system pathology image recognition method of claim 1, wherein the method further comprising:
acquiring original image data, calculating a staining vector matrix and a staining density matrix of the original image data to obtain an original vector matrix and an original density matrix, and calculating a maximum quantile value of an original density matrix as maximum original density data;
calculating a migration coefficient according to maximum reference density data and the maximum original density data, and updating the original density matrix using the migration coefficient to obtain an updated density matrix;
calculating an image matrix to be tested according to a reference vector matrix and the updated density matrix;
wherein, the reference vector matrix is the staining vector matrix of at least one set of high-staining-quality image data, and the maximum reference density data is the maximum quantile value of the staining density matrix of the high-staining-quality image data.

4. The digestive system pathology image recognition method of claim 3, wherein the method specifically comprising:
acquiring the original image data, performing a color space conversion on the original image data, and removing elements in the converted original image data that are less than a preset original threshold to form an original optical density matrix;
calculating covariance of the original optical density matrix independently row by row to form an original covariance matrix, calculating feature vectors according to the original covariance matrix, and performing element screening to obtain an original feature matrix;
projecting the original optical density matrix according to the original feature matrix, calculating an arctangent value of the projected original optical density matrix to obtain an original arctangent matrix, and extracting a maximum quantile arctangent value and a minimum quantile arctangent value from the original arctangent matrix;
calculating a maximum parameter vector corresponding to the maximum quantile arctangent value, and a minimum parameter vector corresponding to the minimum quantile arctangent value, and calculating a first staining vector and a second staining vector according to the original feature matrix;
arranging the first staining vector and the second staining vector according to element values of the two to generate a staining vector matrix of the original image data, thereby obtaining the original vector matrix.

5. The digestive system pathology image recognition method of claim 4, wherein the first staining vector is a dot product of the original feature matrix and the minimum parameter vector, and the second staining vector is a dot product of the original feature matrix and the maximum parameter vector; the method specifically comprising:
determining whether a first element value of the first staining vector is greater than a first element value of the second staining vector;
when the first element value of the first staining vector is greater than the first element value of the second staining vector, arranging the first staining vector to the left of the second staining vector to generate the staining vector matrix of the original image data, thereby obtaining the original vector matrix;
when the first element value of the first staining vector is not greater than the first element value of the second staining vector, arranging the second staining vector to the left of the first staining vector to generate the staining vector matrix of the original image data, thereby obtaining the original vector matrix;
the method further comprising:
performing lasso regression on the original optical density matrix using the original vector matrix as a standard to generate the staining density matrix, thereby obtaining the original density matrix.

6. The digestive system pathology image recognition method of claim 3, wherein the method further comprising:
traversing the image matrix to be tested, segmenting the image matrix to be tested using a sliding window of a preset size to obtain at least two sets of sub-region image data of the image matrix to be tested, and relative position data of the sub-region image data in the image matrix to be tested;
traversing grayscale data of all pixels of the sub-region image data, and calculating a ratio of the number of pixels with grayscale data values less than a preset grayscale threshold to the total number of pixels in the grayscale data, to obtain a tissue area ratio of the sub-region image data;
forming the image data to be tested according to the sub-region image data that meets a preset processing condition, wherein the preset processing condition is: the tissue area ratio of the sub-region image data is greater than a preset ratio threshold.

7. The digestive system pathology image recognition method of claim 1, wherein the method specifically comprising:
acquiring original image data, and constructing a surface image template with the same size as the original image data;
mapping to obtain pseudo-color data corresponding to the final probability values according to the final probability values and RGB mapping curve, and mapping the corresponding pseudo-color data to the surface image template according to relative position data of the predicted sub-region image data to generate a predicted probability distribution image;
setting the predicted probability distribution image with a first weight, setting the original image data with a second weight, and performing weighted mixing on the predicted probability distribution image and the original image data to generate and output a pathological analysis image;
wherein, the relative position data records relative positions of the predicted sub-region image data in the original image data, the values of the first weight and the second weight range from 0 to 1, and the sum of the first weight and the second weight is equal to 1.

8. The digestive system pathology image recognition method of claim 1, wherein the method further comprising:
acquiring a plurality of sets of learning image data, and performing magnification standardization, color transfer standardization, and image matrix segmentation screening on the learning image data to obtain a plurality of sets of sample image data;
dividing the sample image data into a first training set and a first validation set according to a preset ratio;
constructing a convolutional neural network to form and load a weakly supervised learning model, calling an activation function to perform traversal inference on a plurality of first training images in the first training set, and outputting a plurality of training inference probability values corresponding to a plurality of training sub-region image data in the first training images;
sorting the training sub-region image data in descending order according to the training inference probability values, and screening a preset number of high-ranking training sub-region image data to obtain first input image data;
inputting the first input image data and preset diagnostic classification labels corresponding to the first training images into the weakly supervised learning model for training to obtain a first primary parameter set, calculating binary cross-entropy between the training inference probability values and the diagnostic classification labels as a first-order loss function of the first primary parameter set, and updating the weakly supervised learning model with the first primary parameter set;
iteratively training until first-order loss function values converge to a preset loss interval, generating a plurality of first primary parameter sets, corresponding first-order loss function values, and corresponding first input image data;
respectively loading a plurality of weakly supervised learning models under the plurality of first primary parameter sets, performing traversal inference on a plurality of validation images in the first validation set, and outputting a plurality of validation inference probability values corresponding to a plurality of validation sub-region image data in the first validation images;
screening the plurality of validation inference probability values to obtain a maximum validation inference probability value as a comprehensive inference probability value of the first validation image, and calculating binary cross-entropy between the comprehensive inference probability value and the diagnostic classification label of the first validation image as a second-order loss function of the first primary parameter set;
evaluating the second-order loss function values of the plurality of first primary parameter sets comprehensively to obtain the first loss function value, and selecting the first primary parameter set corresponding to the first loss function value as the first model parameter set.

9. The digestive system pathology image recognition method of claim 8, wherein the method further comprising:
acquiring the first input image data corresponding to the first model parameter set;
removing a fully-connected layer of the weakly supervised learning model to form a feature extraction model, and extracting feature vectors of the first input image data according to the first model parameter set to form a learning feature sequence;
dividing the learning feature sequence into a second training set and a second validation set according to a preset ratio;
constructing a recurrent neural network to form and load a long short-term memory learning model, calling an activation function to perform traversal inference on a plurality of second training images in the second training set, and outputting a plurality of training inference probability values corresponding to a plurality of training sub-region image data in the second training images;
sorting the training sub-region image data in descending order according to the training inference probability values, and screening a preset number of high-ranking training sub-region image data to obtain a second input image data;
inputting the second input image data and preset diagnostic classification labels corresponding to the second training images into the long short-term memory learning model, training to obtain a second primary parameter set, calculating binary cross-entropy between the training inference probability values and the diagnostic classification labels as a first-order loss function of the second primary parameter set, and updating the long short-term memory learning model with the second primary parameter set;
loading the long short-term memory learning model under the second primary parameter set, performing traversal inference on a plurality of second validation images in the second validation set, and outputting a plurality of validation inference probability values corresponding to a plurality of validation sub-region image data in the second validation images;
screening the plurality of validation inference probability values to obtain a maximum validation inference probability value as a comprehensive inference probability value of the second validation image, and calculating binary cross-entropy between the comprehensive inference probability value and the diagnostic classification label of the second validation image as a second-order loss function of the second primary parameter set;
iteratively training and validating until second-order loss function values converge to a preset loss interval to generate a plurality of second primary parameter sets, corresponding second-order loss function values, and corresponding second input image data;
comprehensively evaluating the second-order loss function values of the plurality of second primary parameter sets to obtain the second loss function value, and taking the second primary parameter set corresponding to the second loss function value as the second model parameter set.

10. The digestive system pathology image recognition method of claim 1, wherein the method specifically comprising:
acquiring the intermediate feature sequence to form a plurality of nodes;
calculating a forget gate output value by performing sigmoid activation according to a forget gate weight matrix, current node value, output value of a previous node hidden layer, and forget gate bias vector;
calculating a node update value by performing sigmoid activation according to an input gate weight matrix, the current node value, the output value of the previous node hidden layer, and input gate bias vector;
calculating a candidate state update value by performing tan h activation according to a candidate state weight matrix, the current node value, the output value of the previous node hidden layer, and candidate state bias vector;
calculating a current node state value according to the forget gate output value, previous node state value, the node update value, and the candidate state update value;
calculating an output gate output value by performing sigmoid activation according to a output gate weight matrix, the current node value, the output value of the previous node hidden layer, and output gate bias vector;
performing tan h activation on the current node state value and calculating output value of a current node hidden layer according to the activated node state value and the output gate output value;
taking the output value of the hidden layer as the final probability value of the intermediate feature sequence and outputting it.

11. A digestive system pathology image identification system, comprising a data acquisition module, a first-order neural network, and a second-order neural network, wherein:
the data acquisition module is used to acquire image data to be tested;
the first-order neural network, configured as a convolutional neural network, is used to form and load a first learning model, and perform regional traversal prediction on the image data to be tested with a first model parameter set, to obtain a plurality of predicted probability values corresponding to a plurality of sub-region image data;
screen the sub-region image data whose predicted probability values meet a preset assessment condition, to form an intermediate image data set, and extract feature vectors of the intermediate image data set according to the first model parameter set to form an intermediate feature sequence;
the second-order neural network, configured as a recurrent neural network, is used to form and load a second learning model, and execute a traversal prediction on the intermediate feature sequence by means of a second model parameter set, and generate and output pieces of predicted sub-region image data and final probability values of the pieces of predicted sub-region image data according to the sub-region image data, the final probability value of which meet a preset output condition.

12. A computer storage medium storing a computer program, wherein, when the computer program is executed by a processor, the digestive system pathology image recognition method is implemented; the digestive system pathology image recognition method comprising:
acquiring image data to be tested;
constructing a convolutional neural network to form and load a first learning model, and performing regional traversal prediction on the image data to be tested with a first model parameter set, to obtain a plurality of predicted probability values corresponding to a plurality of sub-region image data;
screening the sub-region image data whose predicted probability values meet a preset assessment condition, to form an intermediate image data set, and extracting feature vectors of the intermediate image data set according to the first model parameter set to form an intermediate feature sequence;
constructing a recurrent neural network to form and load a second learning model, and executing a traversal prediction on the intermediate feature sequence by means of a second model parameter set, and generating and outputting pieces of predicted sub-region image data and final probability values of the pieces of predicted sub-region image data according to the sub-region image data, the final probability value of which meet a preset output condition.
